(19) United States
(12) Patent Application Publication
(10) Pub. No.: US 2025/0060450 A1
(43) Pub. Date: Feb. 20, 2025

(54) METHOD AND SYSTEM FOR OBJECT DETECTION AND COUNTERMEASURES

(71) Applicant: Avgarde Systems Private Limited, Bengaluru (IN)

(72) Inventors: Nilutpal Choudhury, Bengaluru (IN); Manash Pratim Bhuyan, Bengaluru (IN); Nihar Kanta Sahoo, Kuhudi (IN); Pournamy S, Bengaluru (IN); Stephin George, Bengaluru (IN); Ajay R, Bengaluru (IN); Ravikumar G, Bengaluru (IN); Raghavendra Murgod, Ramdurg (IN)

(21) Appl. No.: 18/804,371

(22) Filed: Aug. 14, 2024

(30) Foreign Application Priority Data
Aug. 14, 2023 (IN) 202331054683

(51) Int. Cl. G01S 7/02; B64U 20/80; B64U 101/00; G01S 7/41; G01S 13/58

(52) U.S. Cl. CPC G01S 7/021; B64U 20/80; G01S 7/415; G01S 13/584; B64U 2101/00; B64U 2201/20

(57) ABSTRACT

The present disclosure describes a system and a method for object detection and counter measures. A signal reflected by an object in an environment is conditioned to improve various parameters such as signal to noise ratio, spectral resolution, color mapping, or the like. A determination whether the object is unmanned aerial vehicle is based on an output of a trained AI model. The trained AI model classifies the detected object into a category based on the conditioned signal. Additionally, a jammer and spoofer are orchestrated based on determination that the object is an unmanned aerial vehicle. A control of the object is achieved based on the orchestration to perform counter measures such as jamming and spoofing.

### CROSS-REFERENCE TO RELATED APPLICATIONS

This patent application refers to, claims priority to, and claims the benefit of Indian provisional application No. 202331054683 filed on Aug. 14, 2023.

### TECHNICAL FIELD

The present disclosure relates generally to detection of objects in an environment, and more particularly, to classification and detection of unmanned aerial objects vis-à-vis other aerial objects, and taking countermeasure based on the detection of unmanned aerial objects.

### BACKGROUND

Current advances in technology with respect to unmanned aerial vehicles (UAVs) such as drones are finding wide publicity and are used in various applications. The complexity of the operation and the vulnerabilities associated with the UAVs especially in terms of security pose a significant challenge to public safety, critical infrastructure, aviation industry, and establishments that take care of security-related need of a given environment, etc. For example, issues concerning low-altitude airspace management are a growing concern due to constant changes relating to environmental factors, urban topography, and other factors. This dynamic nature of the factors exacerbates the lack of real-time low-altitude airspace data, increasing the risk of potential collisions of these UAVs, and thereby compromising safety. To address the issue of potential misuse of UAVs, there is a requirement for intelligent methods and systems capable of detecting and countering UAVs, effectively. Moreover, to prevent threats such as bird aircraft strike hazard (BASH), and detecting birds, bats, and other flying objects, it becomes paramount to safeguard low-altitude airspace.

Current detection technologies used for detecting UAVs exhibit numerous drawbacks that hinder their effectiveness. For example, radio frequency (RF) detection is hindered by limited range, signal interference, clutter, and precision issues, in addition to line-of-sight requirements. Other examples include acoustic sensors that face limitations such as detection range constraints, susceptibility to noise interference, variability in drone sound signatures, and false positives that may arise from environmental conditions surrounding the detection system. Furthermore, examples include electro-optical/infrared (EO/IR) cameras that suffer from constrained field of view, weather sensitivity, optical zoom restrictions, nighttime limitations, complexity in training data, real-time processing, and adaptability to various environments. Other methods such as drone capture nets and interceptors are confined to short-range countermeasures. Additionally, these technologies are further encumbered by high costs, integration complexities, scalability issues, vulnerability to advanced drone techniques, and regulatory considerations.

Therefore, there is a need to address the shortcomings of existing detection methods and countermeasures while providing a comprehensive and adaptable one-stop solution to low-altitude airspace security and management.

### SUMMARY

Methods and systems for object detection and countermeasures are provided substantially as shown in and described in connection with, at least one of the figures, as set forth more completely in the claims.

In an embodiment of the present disclosure, a method for object detection and countermeasures is provided. The method comprises receiving a signal reflected by an object in an environment. The method further comprises conditioning the received signal to vary one or more parameters associated with the received signal. Additionally, the method comprises providing the conditioned signal as an input to a trained artificial intelligence (AI) model and determining whether the object is an unmanned aerial vehicle (UAV) based on an output of the trained AI model.

In another embodiment of the present disclosure, a method for controlling an object is provided. The method comprises receiving a trigger signal that is indicative of a range and a velocity of an unmanned aerial vehicle (UAV). The method further comprises activating a jammer for a first time-period in response to receiving the trigger signal. One or more jamming signals are transmitted by the jammer based on the range and the velocity of the UAV during the first time-period. Further, the method comprises deactivating the jammer at the completion of the first time-period. Additionally, the method comprises activating a spoofer at the completion of the first time-period. One or more spoofing signals are transmitted by the spoofer. Further, the method comprises calibrating power of the one or more spoofing signals based on the range of the UAV, wherein communication is established between the UAV and the spoofer by the calibrated one or more spoofing signals. The method further comprises remotely maneuvering one or more control functions of the UAV based on the communication established between the UAV and the spoofer.

In yet another embodiment of the present disclosure, a system for object detection and countermeasures is disclosed. The system comprises a processing unit and a trained artificial intelligence (AI) model. The processing unit is configured to receive a signal reflected by an object in an environment and condition the received signal to vary one or more parameters associated with the received signal. Further, the trained AI model is configured to receive the conditioned signal and classify the object into one of a plurality of classes based on the conditioned signal. The processing unit is further configured to determine whether the object is an unmanned aerial vehicle (UAV) based on the classification of the object into one of the plurality of classes.

In some embodiments, the conditioning of the received signal comprises performing a Short Time Fourier Transform (STFT) on the received signal to obtain a set of micro-doppler signatures and intensity transformation on the set of micro-doppler signatures to obtain a transformed set of micro-doppler signatures. Additionally, at least one of a spectral resolution or a signal-to-noise ratio (SNR), of the transformed set of micro-doppler signatures is improved in comparison to a spectral resolution and an SNR, of the set of micro-doppler signatures. Further, the one or more parameters include the spectral resolution and the SNR. Also, the conditioned signal corresponds to the transformed set of micro-doppler signatures.

In some embodiments, the conditioning of the received signal comprises performing a Short Time Fourier Transform (STFT) on the received signal to obtain an intensity plot and intensity transformation on the intensity plot to obtain a transformed intensity plot. Further, at least one of a color mapping or a signal-to-noise ratio (SNR), of the transformed intensity plot is improved in comparison to a color mapping and an SNR, of the intensity plot. Additionally, the one or more parameters include the color mapping and the SNR. Also, the conditioned signal corresponds to the transformed intensity plot.

In some embodiments, the method comprises training an AI model based on a dataset to obtain the trained AI model. The dataset includes a plurality of micro-doppler signatures associated with a plurality of classes.

In some embodiments, the method comprises retraining the trained AI model based on the output of the trained AI model.

In some embodiments, the environment corresponds to an airspace.

In some embodiments, the method comprises detecting a range and a velocity of the object, based on the received signal. The signal is conditioned in response to detecting the range and the velocity of the object. The method further comprises taking over control of the object based on the range and the velocity, in response to the determination that the object is the UAV.

In some embodiments, taking over the control of the object comprises activating a jammer for a first time-period based on the determination that the object is the UAV. One or more jamming signals are transmitted by the jammer based on the range and the velocity of the object during the first time-period. Further, taking over the control of the object comprises deactivating the jammer after the completion of the first time-period, activating a spoofer after the completion of the first time-period, where one or more spoofing signals are transmitted by the spoofer, and calibrating power of the one or more spoofing signals based on the range of the object. Communication is established between the object and the spoofer by the calibrated one or more spoofing signals. Further, remotely maneuvering one or more control functions of the object based on the communication established between the object and the spoofer.

In some embodiments, the method comprises detecting a range of the object based on the received signal. The signal is conditioned in response to detecting the range of the object. The method further comprises determining free space path loss based on the range of the object and activating a spoofer. One or more spoofing signals are transmitted by the spoofer. Additionally, the method comprises calibrating power of the one or more spoofing signals based on the free space path loss such that communication is established between the object and the spoofer by the calibrated one or more spoofing signals. The method further includes remotely maneuvering one or more control functions of the object based on the communication established between the object and the spoofer.

In some embodiments, the method comprises detecting a range of the object based on the received signal. The signal is conditioned in response to detecting the range of the object. The method further comprises determining a phase delay based on the range of the object and activating a spoofer. One or more spoofing signals are transmitted by the spoofer. Further, the method includes calibrating a phase of each of the one or more spoofing signals based on the phase delay such that communication is established between the object and the spoofer by the calibrated one or more spoofing signals. The method additionally comprises remotely maneuvering one or more control functions of the object based on the communication established between the object and the spoofer.

In some embodiments, the system further comprises a jammer coupled to the processing unit and a spoofer coupled to the jammer and the processing unit. The processing unit is configured to detect a range and a velocity of the object based on the received signal. The signal is conditioned in response to detecting the range and the velocity of the object. The processing unit is further configured to orchestrate the jammer and the spoofer based on the range and the velocity, in response to the determination that the object is the UAV, to achieve a control of the object.

### BRIEF DESCRIPTION OF DRAWINGS

The following detailed description of the embodiments of the present disclosure will be better understood when read in conjunction with the appended drawings. The present disclosure is illustrated by way of example, and not limited by the accompanying figures, in which like references indicate similar elements.

FIG. 1A is a diagram that illustrates a system environment for facilitating object detection and countermeasures, in accordance with an embodiment of the present disclosure;

FIG. 1B is a diagram that illustrates an example scenario for signal conditioning, in accordance with an embodiment of the present disclosure;

FIG. 2 is a schematic block diagram that illustrates a counter-unmanned aerial vehicle (UAV) system, in accordance with an embodiment of the present disclosure;

FIG. 3A represents graphs that illustrate orchestration of a jamming operation and a spoofing operation, in accordance with an embodiment of the present disclosure;

FIG. 3B is a diagram that illustrates spoofing, in accordance with an embodiment of the present disclosure;

FIGS. 4A and 4B represent a flowchart that illustrates a method for object detection and countermeasures, in accordance with an embodiment of the present disclosure; and

FIGS. 5A and 5B represent a flowchart that illustrates a method for controlling an object, in accordance with an embodiment of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

The following describes technical solutions in example embodiments of the subject matter of the present disclosure with reference to the accompanying drawings. In this application as disclosed herein, “at least one” means one or more, and “a plurality of” means two or more. The term “and/or” describes an association relationship for describing associated objects and represents that three relationships may exist. For example, A and/or B may represent the following cases: Only A exists, both A and B exist, and only B exists, where A and B may be singular or plural. The character “/” usually indicates an “or” relationship between the associated objects. “At least one item (piece) of the following” or a similar expression thereof means any combination of the items, including any combination of singular items (piece) or plural items (pieces). For example, at least one item (piece) of a, b, or c may represent a, b, c, a and b, a and c, b and c, or a, b, and c, where a, b, and c each may be singular or plural.

It should be noted that in this application articles “a”, “an” and “the” are used to refer to one or to more than one (i.e., to at least one) of the grammatical object of the article. The terms “comprise” and “comprising” are used in the inclusive, open sense, meaning that additional elements may be included. It is not intended to be construed as “consists of only”. Throughout this specification defined above, unless the context requires otherwise the word “comprise”, and variations such as “comprises” and “comprising”, will be understood to imply the inclusion of a stated element or step or group of elements or steps but not the exclusion of any other element or step or group of elements or steps. The term “including” is used to mean “including but not limited to”. “Including” and “including but not limited to” are used interchangeably. In the structural formulae given herein and throughout the present disclosure, the following terms have been indicated meaning, unless specifically stated otherwise.

Unless otherwise defined, all terms used in the disclosure, including technical and scientific terms, have meaning as commonly understood by one of ordinary skill in the art to which this invention belongs. By means of further guidance, term definitions are included for better understanding of the present disclosure. The term ‘about’ as used herein when referring to a measurable value such as a parameter, an amount, a temporal duration, and the like, is meant to encompass variations of ±10% or less, preferably ±5% or less, more preferably ±1% or less and still more preferably ±0.1% or less of and from the specified value, insofar such variations are appropriate to perform the present disclosure. It is to be understood that the value to which the modifier ‘about’ refers is itself also specifically, and preferably disclosed.

It should be noted that in this application, the term such as “example” or “for example” or “exemplary” is used to represent giving an example, an illustration, or descriptions. Any embodiment or design scheme described as an “example” or “for example” in this application should not be explained as being more preferable or having more advantages than another embodiment or design scheme. Exactly, use of the word such as “example” or “for example” is intended to present a related concept in only a specific manner.

In the embodiments of the present subject matter it should be understood that “B corresponding to A” indicates that B is associated with A, and B can be determined based on A. However, it should be further understood that determining B based on A does not mean that B is determined based on only A. B may alternatively be determined based on A and/or other information.

In the embodiments of this present disclosure, “a plurality of” means two or more than two. Descriptions such as ‘first”, “second” in the embodiments of this application are merely used for indicating and distinguishing between described objects, do not show a sequence, do not indicate a specific limitation on a quantity of devices in the embodiments of this application, and do not constitute any limitation on the embodiments of this application.

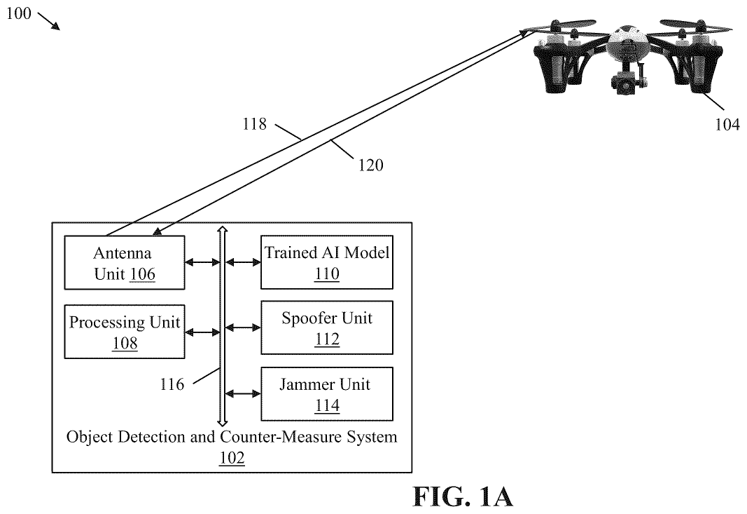

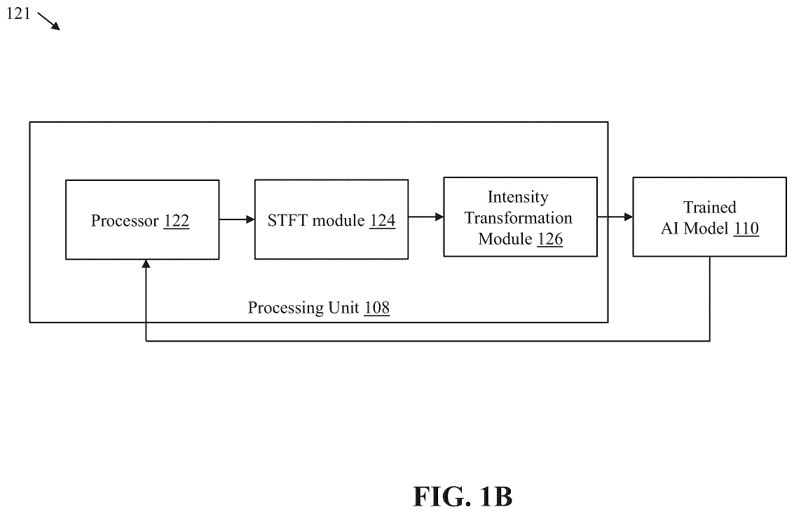

FIG. 1A is a diagram that illustrates a system environment 100 for facilitating object detection and countermeasures, in accordance with an embodiment of the present disclosure. The system environment 100 is shown to include an object detection and counter-measure system 102 and an object 104. The object detection and counter-measure system 102 is hereinafter referred to as “the system 102”. The system 102 may include an antenna unit 106, a processing unit 108, a trained artificial intelligence (AI) model 110, a spoofer unit 112, and a jammer unit 114. The antenna unit 106, the processing unit 108, the trained AI model 110, the spoofer unit 112, and the jammer unit 114 may be coupled to each other via a communication bus 116.

The antenna unit 106 may include one or more transmitting antennas and one or more receiving antennas for transmitting and receiving one or more signals, respectively in the electromagnetic spectra. In an example, the antenna unit 106 may correspond to a Radio Detection and Ranging (RADAR) unit. The antenna unit 106 may be configured to transmit one or more signals to detect any objects (such as the object 104) within a predefined range in any environment. In further embodiments, the one or more signals may correspond to RADAR signals. RADAR signals are a type of electromagnetic wave, specifically within microwave and radio wave frequencies. In an embodiment, the environment may correspond to airspace. In an example, the predefined range in the environment may correspond to low-altitude airspace. In a further example, the low altitude airspace may correspond to airspace at less than or equal to 5 kilometers from the ground level.

In an example scenario, the antenna unit 106 may transmit a signal 118. The antenna unit 106 may receive a signal 120 in response to the transmitted signal 118. In other words, the received signal 120 may correspond to the signal 118 that is reflected/rebound by the object 104. The object 104 may correspond to one of an unmanned aerial vehicle (UAV), a bird, or any other aerial object. A UAV (such as a drone) is an aircraft without a human pilot on board. UAVs can be controlled either autonomously by onboard computers or remotely by human operators.

In numerous embodiments, the received signal 120 may be referred to as a RADAR signature. A RADAR signature can represent a set of characteristics of the reflected signal that provide information about the object 104. For example, the received signal 120 may be indicative of RADAR cross section (RCS), reflection characteristics, and micro-Doppler signatures. The RCS may refer to a measure of how much RADAR energy is reflected to the system 102. Further, the reflection characteristics may indicate a pattern of how the signal 118 was scattered or reflected from the object 104. Additionally, the micro-Doppler signature may include details on small-scale movements or rotating components of the object 104. The antenna unit 106 may be further configured to provide the signal 120 to the processing unit 108.

The processing unit 108 may include suitable logic, circuitry, interfaces, and/or code executable by the circuitry for facilitating object detection and countermeasures. In an embodiment, the processing unit 108 may be a combination of a field programmable gate array (FPGA) processor and an embedded processor (such as a microcontroller, microprocessor, or the like). The processing unit 108 may be configured to receive the signal 120 from the antenna unit 106. The processing unit 108 may be further configured to determine a range and a velocity of the object 104 based on the received signal. Further, the processing unit 108 may be configured to condition the signal 120 to vary one or more parameters associated with the signal 120. The conditioning of the signal 120 is explained in detail in conjunction with FIG. 1B. The processing unit 108 may be further configured to provide the conditioned signal 120 as an input to the trained AI model 110. In response, the processing unit 108 may receive an output from the trained AI model 110. Further, the processing unit 108 may be configured to determine whether the object 104 is a UAV based on the output of the trained AI model 110, for example, based on a classification performed by the trained AI model 110.

In further embodiments, the processing unit 108 may be configured to train an AI model based on a dataset such as a plurality of micro-Doppler signatures associated with a plurality of classes to obtain the trained AI model 110. The plurality of classes may include a category of birds, a category of drones, a category of clutters, a category of noises, or the like. Micro-Doppler signatures are subtle variations in the Doppler frequency shift of RADAR signals that arise from the movement of small components on a larger, moving object. The Doppler effect, which causes a shift in the frequency of reflected waves due to relative motion, is primarily used to determine a velocity of an object. However, if the object has smaller, independently moving parts (such as rotating blades, flapping wings, or swinging limbs), such components induce additional Doppler shifts that create distinct spectral features superimposed on the main Doppler shift. Micro-Doppler signatures enable detailed characterization of motion of the object and the dynamics of smaller moving parts of the object. Thus, each class of the plurality of classes is associated with one or more micro-Doppler signatures. Additionally, the processing unit 108 may be further configured to retrain the trained AI model 110 based on the output of the trained AI model 110.

The processing unit 108 may be further configured to trigger at least one of the spoofer unit 112 and the jammer unit 114 in response to the determination that the object 104 is the UAV. The spoofer unit 112 and/or the jammer unit 114 can be triggered to take over (or achieve) control of the object 104.

In further additional embodiments, the processing unit 108 may be further configured to orchestrate the jammer unit 114 and the spoofer unit 112 to achieve control of the object 104. The orchestration of the jammer unit 114 and the spoofer unit 112 may comprise the following operations. The processing unit 108 may be configured to activate the jammer unit 114 for a first time-period upon the determination that the object 104 is the UAV. Upon activation, one or more jamming signals are generated and transmitted by the jammer unit 114 during the first time-period. Further, the processing unit 108 may be configured to deactivate the jammer unit 114 after the completion of the first time-period. The processing unit 108 may be further configured to activate the spoofer unit 112 after the completion of the first time-period. One or more spoofing signals may be synthesized upon the activation of the spoofer unit 112. Further, the processing unit 108 may be configured to calibrate power of each of the one or more spoofing signals such that communication is established between the system 102 and the object 104. The processing unit 108 may be further configured to remotely maneuver one or more control functions of the object 104 based on the communication established therebetween. Examples of the one or more control functions may include navigation functions, flight control functions, telemetry functions, motion control functions, or the like.

The trained AI model 110 may refer to a model that can create and train machine learning algorithms that emulate logical decision-making based on available data. The trained AI model 110 may be configured to classify the object 104 into one of the plurality of classes based on the conditioned signal. Examples of the trained AI model 110 may include, but are not limited to, linear regression model, deep neural networks, decision trees, support vector machines, or the like. In an embodiment, the trained AI model 110 may be run on an edge computing processor in the system 102. An edge computing processor may refer to a microprocessor or a system-on-chip (SoC) that is designed to perform data processing tasks locally at or near a data source rather than relying on centralized cloud or data center resources. In various embodiments, the trained AI model 110 may be externally operated such as through a cloud-based service, or a third-party service.

The spoofer unit 112 may include suitable logic, circuitry, interfaces, and/or code executable by the circuitry, to spoof the object 104. Spoofing may refer to a technique that involves manipulating navigation of the object 104 or a control system of the object 104 to take over control of the object 104 or alter the behavior of the object 104. In an example, the spoofer unit 112 may include one or more spoofing antennas that are configured to transmit the one or more spoofing signals. Additionally, the spoofer unit 112 may be controlled by the processing unit 108.

The jammer unit 114 may include suitable logic, circuitry, interfaces, and/or code executable by the circuitry, to jam the object 104. Jamming may refer to creating interference with a communication and/or the control system of the object 104. Thus, the object 104 may fail to navigate in response to the jamming. In an example, the jammer unit 114 may include one or more jamming antennas that are configured to transmit the one or more jamming signals. Additionally, the jammer unit 114 may be controlled by the processing unit 108. The jammer unit 114 and the spoofer unit 112 are further explained in detail in the forthcoming description.

The communication bus 116 may be configured to facilitate communication of data and control signals between various components (such as the antenna unit 106, the processing unit 108, the trained AI model 110, the spoofer unit 112, and the jammer unit 114) of the system 102. Examples of the communication bus 116 may include at least one of Ethernet, RS422, digital input/output bus, or a combination thereof. In an example, Ethernet being used as the communication bus 116 can result in deterministic communication in the system 102.

FIG. 1B is a diagram that illustrates an example scenario 121 for signal conditioning, in accordance with an embodiment of the present disclosure. Referring to FIG. 1B, the example scenario 121 is shown to include the processing unit 108 and the trained AI model 110. The processing unit 108 may include a processor 122, a short-time Fourier transformation (STFT) module 124, and an intensity transformation module 126.

The processor 122 may include suitable logic, circuitry, interfaces, and/or code executable by the circuitry to perform various operations to facilitate object detection and countermeasures. The processor 122 may receive the signal 120, reflected by the object 104, from the antenna unit 106. Further, the processor 122 may condition the signal 120. In some embodiments, to condition the signal 120, the processor 122 may be configured to perform an STFT on the received signal 120 and obtain a set of micro-doppler signatures associated with the received signal 120. Further, the processor 122 may be configured to perform intensity transformation on the set of micro-doppler signatures and obtain a transformed set of micro-doppler signatures.

The processor 122 may pass the signal 120 through the STFT module 124 to perform the STFT on the received signal 120. Further, the set of micro-doppler signatures may be passed through the intensity transformation module 126 to perform the intensity transformation of the set of micro-doppler signatures. The transformed set of micro-doppler signatures may correspond to the conditioned signal that is provided as the input to the trained AI model 110. The intensity transformation of the set of micro-doppler signatures may be performed to improve spectral resolution of the set of micro-doppler signatures as the set of micro-doppler signatures is susceptible to Additive White Gaussian Noise (AWGN) and environmental clutter.

The improvement in the spectral resolution of the set of micro-doppler signatures may further cause an improvement in a signal-to-noise ratio (SNR) of the set of micro-doppler signatures. As a result, the spectral resolution and SNR of the conditioned signal is improved in comparison to that of the received signal 120. In an example, the SNR of the set of micro-doppler signatures is improved by a margin that varies in the range of 6 decibels (dB) to 10 dB. The improvement in the SNR of the conditioned signal can result in increased efficiency in the classification of the object 104 by the trained AI model 110. Additionally, the efficiency of the classification of the object 104 based on the signal 120 with a low received signal strength indicator may be improved due to improvement in the SNR.

In additional embodiments, to condition the signal 120, the processor 122 may be configured to perform the STFT on the received signal 120 and obtain an intensity plot. An intensity plot is a graphical representation of the magnitude spectrum of a signal over time. An intensity plot may illustrate time represented on a horizontal axis, frequency represented on a vertical axis, and intensity (or the magnitude) represented by color or grayscale, where different colors or shades indicate the strength of the frequency components. The processor 122 may further perform intensity transformation on the intensity plot to obtain a transformed intensity plot. The processor 122 may pass the signal 120 through the STFT module 124 and obtain the intensity plot. In other words, IQ data of the signal 120 is STF transformed to obtain transformed data. Further, the processor 122 may be configured to map the magnitude of the transformed data into a color map, thereby converting the transformed data into an image. The color map may correspond to the intensity plot. The IQ data of the signal 120 may refer to a representation of the signal 120 using In-phase (I) and Quadrature (Q) components of the signal 120. In an example, a resolution of the intensity plot can be 224×224, 64×64, 128×128, or the like.

The intensity plot may be passed through the intensity transformation module 126 to obtain the transformed intensity plot. The transformed intensity plot may correspond to the conditioned signal that is provided as the input to the trained AI model 110. A color mapping of the intensity plot may be enhanced by the intensity transformation module 126. Additionally, an SNR of the intensity plot can be enhanced by the intensity transformation module 126. In an example, the SNR of the intensity plot is improved by a margin that varies in the range of 6 dB to 10 dB.

Examples of the processor 122 may include application-specific integrated circuit (ASIC) processor, a reduced instruction set computer (RISC) processor, a complex instruction set computer (CISC) processor, a field programmable gate array (FPGA), a central processing unit (CPU), or the like. In an embodiment, the processor 122 may correspond to an FPGA to ensure accurate operation.

The STFT module 124 and the intensity transformation module 126 may be implemented on an embedded processor such as a microcontroller, microprocessor, or the like. Additionally, the processor 122, the embedded processor, and the edge computing processor implementing the trained AI model 110 may communicate with each other via Ethernet (e.g., the communication bus 116).

In further additional embodiments, the processor 122 may be further configured to determine the range and the velocity of the object 104 prior to performing the signal conditioning of the received signal 120. The processor 122 may determine the range and the velocity of the object 104 based on the received signal 120. In numerous additional embodiments, the processor 122 may be configured to perform the signal conditioning operations in response to the range and/or the velocity of the object exceeding a threshold range and a threshold velocity, respectively.

The trained AI model 110 may provide the output that is indicative of a classification of the object 104 to the processor 122. The processor 122 may be further configured to determine whether the object 104 is the UAV based on the output of the trained AI model 110. Further, the processor 122 may initiate jamming and spoofing operations to countermeasure the object 104 in response to the determination that the object 104 is the UAV.

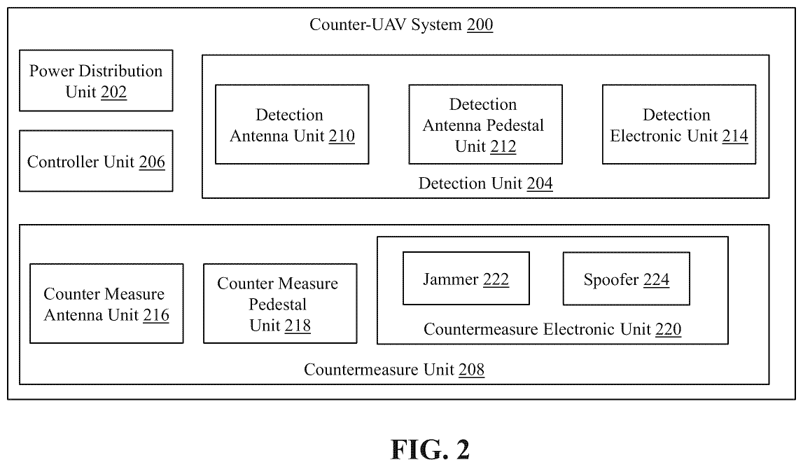

FIG. 2 is a schematic block diagram that illustrates a counter-UAV system 200, in accordance with an embodiment of the present disclosure. The counter-UAV system 200 may be configured to perform object detection and countermeasures. The counter-UAV system 200 may include a power distribution unit 202, a detection unit 204, a controller unit 206, and a countermeasure unit 208.

The power distribution unit 202 may include suitable logic, circuitry, interfaces, and/or code executable by the circuitry to facilitate power distribution in the counter-UAV system 200. The power distribution unit 202 may be coupled to a power source that is configured to provide power supply to the counter-UAV system 200. The power distribution unit 202 may be configured to distribute alternating current (AC)/direct current (DC) power to the detection unit 204, the controller unit 206, and the countermeasure unit 208. In further embodiments, the power distribution unit 202 may be configured to receive AC power from the power source, convert AC power to DC power, and provide DC power supply to various components of the counter-UAV system 200.

The detection unit 204 may include suitable logic, circuitry, interfaces, and/or code executable by the circuitry to facilitate object detection. The detection unit 204 may include a detection antenna unit 210, a detection antenna pedestal unit 212, and a detection electronic unit 214.

The detection antenna unit 210 may include one or more transmitter antennas and one or more receiver antennas operating at a fixed frequency or variable frequency. The detection antenna unit 210 may be configured to transmit and receive one or more signals to facilitate detection of objects. The detection antenna pedestal unit 212 may include a motor that is configured to rotate the detection antenna unit 210, for example, in H-plane (0° to 360°). A scanning rate associated with the detection unit 204 can be determined based on a maximum speed of objects (UAVs) and beamwidths of the transmitter and receiver antennas. The detection antenna pedestal unit 212 may withstand high wind speeds while effectively accommodating a scanning rate varying in the range of up to 60 revolutions per minute (RPM).

The detection electronic unit 214 may include various components such as radio frequency (RF) units and baseband units for facilitating accurate object detection. The detection electronic unit 214 may be configured to generate one or more signals for detection of an object. The detection electronic unit 214 may be further configured to process the generated one or more signals. The processing of the generated one or more signals may include at least one of power amplification, filtering, noise reduction, or the like. Further, the detection electronic unit 214 may provide the processed one or more signals to the transmitter antenna. The transmitter antenna may be configured to transmit each of the one or more processed signals.

In additional embodiments, each signal may correspond to a waveform. Further, the waveform may be transmitted with high sampling rates to an object (such as the object 104). For example, the waveform being transmitted may be a frequency modulated continuous wave (FMCW) waveform with a bandwidth based on scenarios associated with the object. In an example, the waveform is sampled at a high rate of 200 Mega Samples Per Second (MSPs). The detection electronic unit 214 may sample the waveform. In such an example, the waveform spans a total duration of 327.68 microseconds. Each time the waveform frequency rises from 0 to 35 megahertz (MHz), corresponds to a chirp. A group of 128 chirps, collectively known as a frame, is transmitted at each azimuthal angle. Each frame is transmitted by the transmitter antenna. The process of generating and transmitting each frame may approximately span around 42 milliseconds.

The transmitter antenna may send a trigger signal to the detection antenna pedestal unit 212 upon the transmission of a frame. The trigger signal may instruct the detection antenna pedestal unit 212 to move the motor to a next position. The transmitter antenna may further await an acknowledgment trigger from the detection antenna pedestal unit 212 that confirms the successful movement of the motor to the intended position. The transmitter antenna may then proceed to send out the next frame upon receiving the acknowledgment trigger, thereby initiating the cycle once again.

The receiver antenna of the detection antenna unit 210 may be synchronized with the transmitter antenna of the detection antenna unit 210. The receiver antenna may be configured to actively receive signals during the transmission, and suspend acceptance of any signal during the operation of the detection antenna pedestal unit 212.

The detection electronic unit 214 may be further configured to process the signal received by the receiver antenna. The processing of the received signal may include power amplification, enhancement of receiver gain, filtering, noise reduction, analog to digital conversion, or the like, In an example, the detection electronic unit 214 may decimate the signal received by the receiver antenna to retain relevant information. The received signal may correspond to a signal reflected by the object. Further, the detection electronic unit 214 may conjugate and multiply the decimated signal with a copy of the transmitted signal. The conjugate-multiplication results in a sinusoidal signal, also referred to as the beat signal, where a frequency of the beat signal is directly related to a delay in the received signal. The detection electronic unit 214 may be configured to provide the processed signal (for example, the beat signal) to the controller unit 206.

In additional embodiments, an independent built-in test procedure may be provided in detection electronic unit 214 to ensure the health status of all the subsystems of the detection unit 204. As part of the continuous health monitoring, a coupled power from the RF frontend and temperature monitoring are included and any degradation or fault condition may be intimated in a user interface of the counter-UAV system 200. A record of all the fault occurrences may be maintained for further inspection.

The controller unit 206 may include suitable logic, circuitry, interfaces, and/or code executable by the circuitry to perform various operations. In additional embodiments, the controller unit 206 may be configured to provide computational, processing, and health monitoring platform for the counter-UAV system 200. In numerous embodiments, the controller unit 206 may include the processing unit 108 and the trained AI model 110. Thus, the controller unit 206 may correspond to a combination of an FPGA, an embedded processor, an edge computing processor, or the like.

The controller unit 206 may be configured to receive the processed signal from the detection unit 204. In an embodiment, the FPGA portion of the controller unit 206 may receive the processed signal. Further, the controller unit 206 may be configured to determine a range and a velocity of the detected object based on the received signal. To analyze and capture the velocity of the object, the controller unit 206 may apply a two-stage Fast Fourier Transform (FFT) algorithm often known as a 2D FFT on the received signal. The two-stage FFT algorithm may be implemented on the FPGA portion of the controller unit 206. In the first stage, the first FFT identifies a position of the object by extracting the frequency information from the received signal. In the second stage, the second FFT utilizes phase information derived from the first FFT signal to calculate the velocity of the object. The first FFT may be executed following the conjugate multiplication and decimation of the received signal. The output of the first FFT may be compared against a Constant False Alarm Rate (CFAR) threshold. Additionally, a copy of the first FFT data may be manipulated in Block RAMs to emulate a matrix transpose operation with minimal computational overhead. Upon completion of this process for the entire frame, the output is channeled to the second FFT stage. The output of the second FFT undergoes a similar path.

The controller unit 206 may restructure the data received from the second FFT to be displayed in the form of a Range-Doppler Map (RD Map). The RD Map may represent the range and the velocity of the object in a 2D intensity graph. Thus, the FPGA portion of the controller unit 206 may determine the range and the velocity of the object. In some embodiments, the controller unit 206 may utilize the first FFT data for object detection based on the first FFT data exceeding the CFAR threshold. In response to the first FFT data exceeding the CFAR threshold, the controller unit 206 may integrate the first FFT data over time to obtain an STFT plot. To achieve the feature extraction from the object detection data to account for the temporal information for micro-doppler data, the STFT is utilized. The CFAR techniques are used to control the number of false positives for detecting the object. Additionally, the controller unit 206 may condition the received signal in response to the output of the first FFT exceeding the CFAR threshold.

In several embodiments, to condition the received signal, the received signal may be passed through an STFT module in the controller unit 206 to obtain an intensity plot. Further, the intensity plot may be passed through an intensity transformation module in the controller unit 206 to obtain a transformed intensity plot. In another embodiment, the received signal can be passed through an STFT module in the controller unit 206 to obtain a set of micro-doppler signatures. Further, the set of micro-doppler signatures may be passed through an intensity transformation module in the controller unit 206 to obtain a transformed set of micro-doppler signatures. The STFT module and the intensity transformation module may be implemented on the embedded processor of the controller unit 206.

A trained AI model (such as the trained AI model 110) that corresponds to an Artificial Neural Network architecture, such as, for example, Inception V3, may be used for the classification of objects. The Inception V3 focuses on burning less computational power by modifying the Inception architectures. The transformed intensity plot or the transformed set of micro-doppler signatures that corresponds to an image is provided to the trained AI model as an input. In other words, the FPGA portion of the controller unit 206 may provide the transformed intensity plot or the transformed set of micro-doppler signatures as the input to the trained AI model that is implemented on the edge computing processor of the controller unit 206. The trained AI model is primarily trained on multiple classes, for example, birds, drones, clutter, and noise. Further, the trained AI model may output the class (or category) that the object belongs to.

The controller unit 206 may determine whether the object detected is a UAV based on the output of the trained AI model. The controller unit 206 may sends (or transmit) a trigger signal to the countermeasure unit 208 in response to determining that the object is the UAV. The trigger signal indicates the countermeasure unit 208 to perform at least one of jamming and spoofing.

The countermeasure unit 208 may be configured facilitate neutralization and assume control over the object. The countermeasure unit 208 may include a countermeasure antenna unit 216, a countermeasure pedestal unit 218, and a countermeasure electronic unit 220. The countermeasure electronic unit 220 may include a jammer 222 and a spoofer 224.

The countermeasure antenna unit 216 may include various types of antennas, for example, circularly polarized array antenna, linear polarized array, slant polarized array, MISO array antenna, multilayer circular polarized antenna, or any other type of CP, polarized or patch antenna for facilitating wideband jamming and spoofing. The antennas may be generally configured to emit jamming and/or spoofing signals necessary to disrupt the communication and take control of the detected object. In an example, the countermeasure antenna unit 216 may include 3 jamming antennas and one spoofing antenna to facilitate triangulation of the object.

The countermeasure pedestal unit 218 may include an absolute encoder feedback-based stepper motor configured to rotate the countermeasure antenna unit 216 toward the direction of the detected object and maintain the target-tracked position.

The jammer 222 may include, a microcontroller, an interference generator section, and a solid-state power amplifier section. The interference generator section may comprise a number of dedicated noise sources (such as sawtooth generators and/or noise generators), voltage-controlled oscillators (VCOs), frequency synthesizers, and pre-amplifiers. The solid state power amplifier (SSPA) section may comprise large signal amplifiers to deliver RF power up to 100. The spoofer 224 may include signal generators and power amplifiers that are configured to generate and process spoofing signals. In a number of embodiments, the countermeasure unit 208 may correspond to the spoofer unit 112 and the jammer unit 114.

In operation, upon the determination that the object detected is the UAV, the controller unit 206 may be configured to activate the jammer 222 for a first time-period. During the activation of the jammer 222, the jammer 222 may receive a jamming trigger signal that is indicative of the range and the velocity of the object. Additionally, the controller unit 206 may provide a position signal to the countermeasure pedestal unit 218. In response to receiving the jamming trigger signal, the noise source may generate a noise signal that is modulated across the frequency band using the VCO or frequency synthesizer. In other words, the microcontroller embedded in the jammer 222 may initiate the generation of the noise signal. The modulated noise signal is then subject to amplification through the pre-Amplifier and SSPA stages. The amplified noise signal (e.g., jamming signal) is transmitted via a high-gain antenna of the countermeasure antenna unit 216, effectively creating a disruptive radio frequency signal. The countermeasure antenna unit 216 may be accurately positioned by the countermeasure pedestal unit 218 based on the position signal. The disruptive radio frequency signal is intended to interfere with communication and control systems of the detected object (e.g., UAV) by introducing additional noise/interference in the relevant frequency bands, thereby rendering the communication and navigation of the detected object less effective or accurate. In an example, the jamming signal may be transmitted in frequencies corresponding 2.4 GHz band, 5 GHz band, global positioning system (GPS) bands, or the like. Additionally, multiple such jamming signals are transmitted to the object during the first time-period. In further examples, the first time-period may range between 2 seconds to 20 seconds.

The controller unit 206 may be further configured to deactivate the jammer 222 upon the completion of the first time-period. The jammer 222 may stop transmitting the jamming signals upon the deactivation. Further, the controller unit 206 may be configured to activate the spoofer 224 upon the completion of the first time-period. Upon the completion of the first time-period, the object loses communication with corresponding satellites due to the jamming signals. The activation of the spoofer 224 may include digital synthesis of one or more spoofing signals by the controller unit 206 based on the range and the velocity of the object. The synthesis of the one or more spoofing signal includes calibration of power of each of the one or more synthesized spoofing signals. Further, the synthesized one or more spoofing signals are provided to the spoofer 224.

The spoofer 224 may generate one or more spoofing signals based on the synthesized one or more spoofing signals. Further, the generated one or more spoofing signals are transmitted to the object via an antenna of the countermeasure antenna unit 216. In an example, the countermeasure antenna unit 216 may transmit the generated one or more spoofing signals with a power in the range of about 40 dBm. Communication may be established between the object and the counter-UAV system 200 based on the one or more spoofing signals. The controller unit 206 may control the object based on the communication established therebetween. The operations involving the synthesis of the one or more spoofing signals, the generation of the one or more spoofing signals, the transmission of the one or more spoofing signals, and controlling the object based on the one or more spoofing signals may be referred to as a spoofing operation. Additionally, the operations associated with the spoofing operations and jamming operations are performed by the FPGA portion of the controller unit 206.

The spoofing operation may aim to manipulate global navigation satellite system (GNSS) communication of a receiver of the detected object by modifying the GPS signal that rearranges the positions of the satellites present in space in accordance with the position of the object. Thus, the controller unit 206 and the spoofer 224, in combination produce a counterfeit signal that mimics the radio-frequency signals broadcasted by the GPS satellites.

In numerous embodiments, the controlling of the object may be performed in two modes such as a no-fly zone mode and a GPS maneuvering mode. In the no-fly zone mode, the controller unit 206 may spoof the detected object to a no-fly zone that triggers the detected object to land immediately or prevent the detected object from taking off in the designated area. In the GPS maneuvering mode, the controller unit 206 may maneuver the detected object to a safer location away from the protected/designated area through GPS spoofing.

In numerous additional embodiments, the power received by the object may be vital for the efficacy of the spoofing operation, and hence an automatic gain control (AGC) technique may be implemented by the controller unit 206 to take into account the Free Space Path Loss such that the final spoofing power received by the object is in a range of 5 dB to 10 dB above the power received from a satellite by the object. Thus, the object is prevented from interpreting the received signal to be a spoofing signal and the object reckons the spoofing signal as an actual satellite signal. Further, by simulating false waypoint information at this power level, the intended path of the object is controlled, thereby enabling manipulation of movements of the object based on the deceived navigation cues and altering the path of the object.

In further additional embodiments, a differential delay is introduced in coarse acquisition (C/A) codes of the spoofing signals to mimic satellite signals by the controller unit 206. A distance of the satellite from the object 310 can be approximately 22000 kilometers, and hence there is a Time Delay of Arrival (TDOA) that exists for the satellite signals to reach the object. This delay in time may culminate into a phase delay in coarse acquisition (C/A) codes and carrier phase received by the object. Additionally, these delays are different for different satellites depending upon the real-time position of the satellites. The controller unit 206 may be configured to determine a difference in delay in a path between the counter-UAV system 200 and the object and delay in a path between the satellite and the object. Thus, the controller unit 206 may achieve control of the object based on the spoofing signals with differential delay.

In further additional embodiments, the counter-UAV system 200 may include a host computer responsible for hosting non-deterministic processes including a graphical user interface (GUI). In numerous additional embodiments, various components in the counter-UAV system 200 may communicate with each other via a communication bus (such as the communication bus 116).

In furthermore embodiments of the present disclosure, the detection and determination of the object may be used as a method for controlling vehicle traffic control. The method may include the steps of determining the position information of an UAV and then sequentially assigning a predetermined area/distance for each vehicle with respect to either a predetermined reference coordinate point or with respect to other vehicles. In some embodiments, the detection and deflection of UAVs may be utilized for the protection of critical infrastructure.

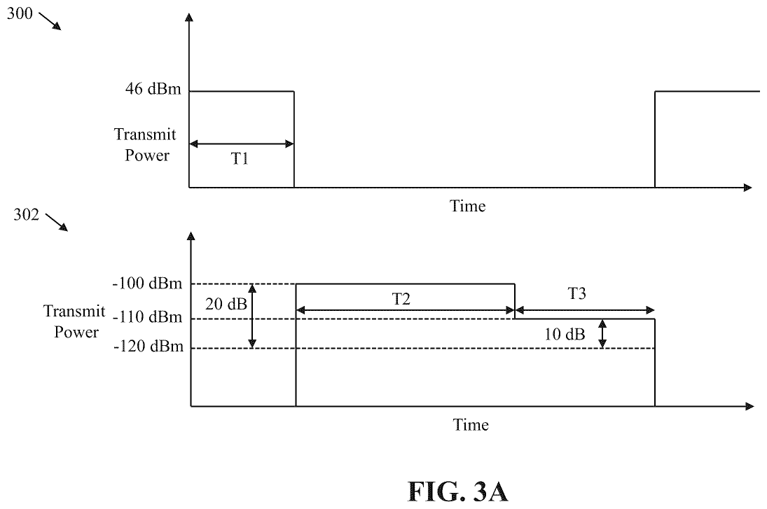

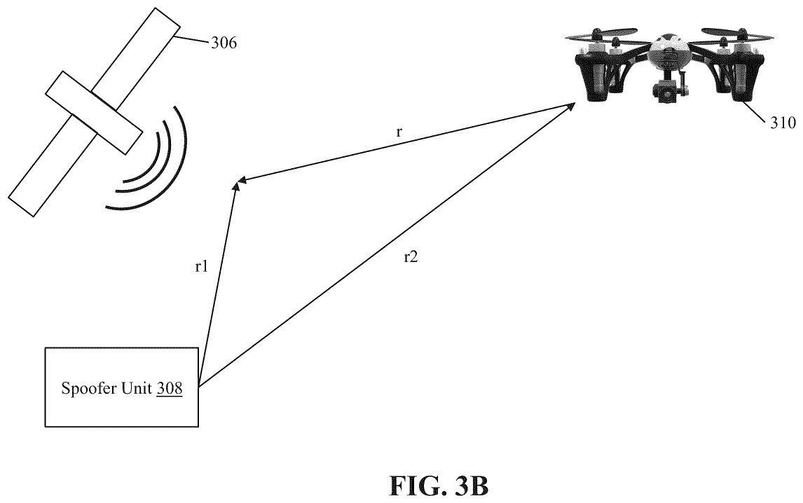

FIG. 3A represents graphs 300 and 302 that illustrate the orchestration of a jamming operation and a spoofing operation, in accordance with an embodiment of the present disclosure. The graph 300 represents time on the horizontal axis and transmit power of a jammer (such as the jammer unit 114 and jammer 222) on the vertical axis. Further, the graph 302 represents time on the horizontal axis and transmit power of a spoofing signal generated by a spoofer (such as the spoofer unit 112 and the spoofer 224) during the spoofing operation on the vertical axis.

The jammer may be activated for the first time-period (for example, T1 seconds such as 5 seconds, 6 seconds, 7 seconds, etc.) based on the determination that the object is the UAV. The jammer may transmit the one or more jamming signals to the object based on the velocity and the range of the object during the first time-period. In an example, power of the jamming signals transmitted by the jammer can be 46d Bm. In other words, the transmit power of the jammer is 46 dBm. The jammer is deactivated upon the completion of the first time-period (e.g., T1). Further, the spoofer is activated upon the completion of the first time-period and deactivation of the jammer. In response to the activation, the spoofer may transmit the one or more spoofing signals. The power of the spoofing signals can be calibrated based on the range of the object. The power of the spoofing signals is calibrated such that a margin between the power of the spoofing signal and the actual satellite signal is 20 dB. Additionally, time delay of arrival may be computed and the spoofer is turned on for a second time-period to achieve satellite locking. In an example, the power of the spoofing signal can be maintained at −100 dBm for T2 seconds (e.g., 45, 50, or 60 seconds) to achieve satellite locking. Further, the spoofing power is reduced to −110 dBm for the next T3 seconds (e.g., 15, 20, 30 seconds, etc.) to keep the margin between the power of the spoofing signal and the actual satellite signal to 10 dB as power of the actual satellite signal is −120 dBm. Thus, communication is established with the object. As a result, satellite fix where the object is able to triangulate and a localization point/position fix is achieved. In other words, the satellite fix may be achieved during the T3 seconds. It should be noted that control of the object is achieved upon achieving the satellite fix.

FIG. 3B is a diagram that illustrates spoofing, in accordance with an embodiment of the present disclosure. FIG. 3B is shown to include a satellite 306, a spoofer unit 308, and an object 310. The object 310 is determined to be a UAV. The spoofer unit 308 may include the FPGA portion of the controller unit 206, the countermeasure antenna unit 216, the countermeasure pedestal unit 218, the spoofer 224, and a Commercial Off the Shelf (COTS) GPS receiver. The COTS GPS receiver may be configured to detect the coordinates of the spoofer unit 308. Further, the spoofer unit 308 may receive coordinates of the object 310 from a detection unit (such as the detection unit 204).

A distance of the satellite from the object 310 is approximately 22000 kilometers, and hence there is a Time Delay of Arrival (TDOA) that exists for the satellite signals to reach the object. This delay in time culminates into a phase delay in coarse acquisition (C/A) codes and carrier phase received by the object 310. Additionally, these delays are different for different satellites depending upon the real-time position of the satellites. The spoofer unit 308 may determine a difference in delay in a path between the spoofer unit 308 and the object 310 and delay in a path between the satellite 306 and the object 310. The spoofer unit 308 may further introduce a differential delay in the C/A codes of the spoofing signals, thereby mimicking the satellite signals. Thus, the spoofer unit 308 may achieve control of the object 310 based on the spoofing signals with differential delay. In the example case, the following equations (1), (2), and (3) can be used to determine the differential delay.

$$r = \vert \vec{r 1} - \vec{r 2} \vert$$

$$t = r / c$$

$$p = t * ( 2 * p i * f )$$

where,
\vec{r1} corresponds to a range between the spoofer unit 308 and the satellite 306,
\vec{r2} corresponds to a range between the spoofer unit 308 and the object 310,
r corresponds to a range between the satellite 306 and the object 310,
t corresponds to a time delay,
c corresponds to speed of light,
p corresponds to phase delay (i.e., differential delay), and
f corresponds to frequency.

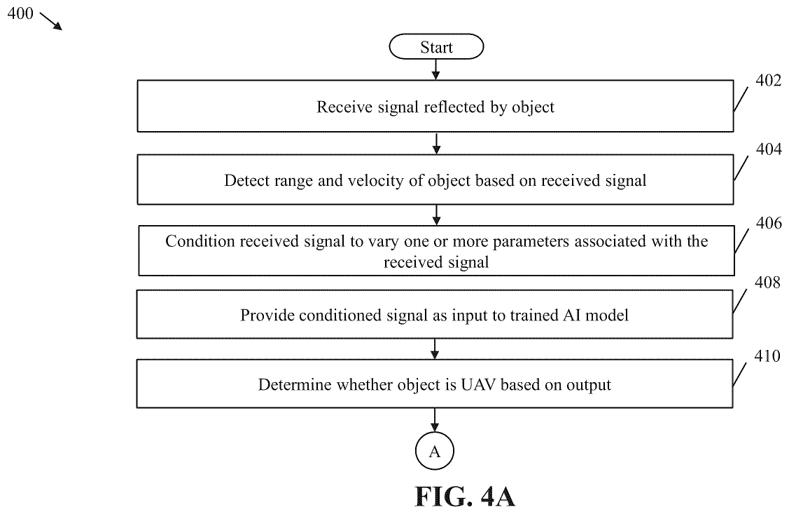

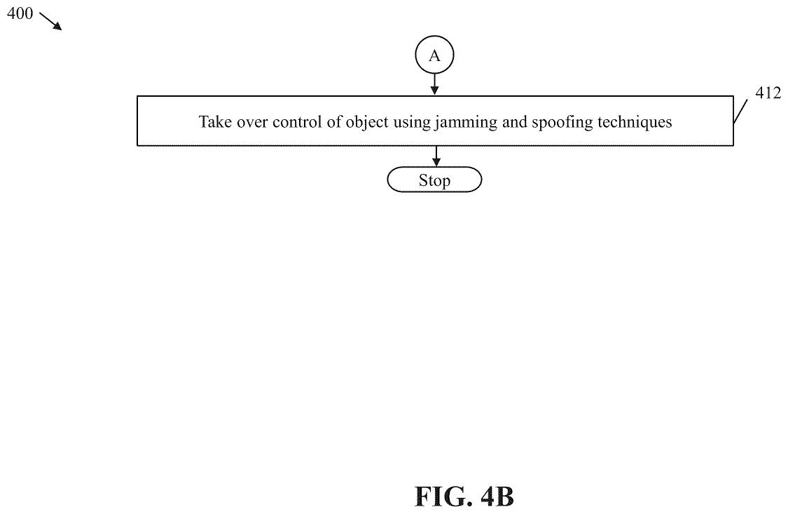

FIGS. 4A and 4B represent a flowchart 400 that illustrates a method for object detection and countermeasures, in accordance with an embodiment of the present disclosure. Referring to FIG. 4A, at 402, the method includes receiving a signal (such as the signal 120) that is reflected by an object (such as the object 104). At 404, the method includes detection of a range and a velocity of the object based on the received signal. At 406, the method includes conditioning of the received signal to vary one or more parameters associated with the received signal. The one or more parameters correspond to at least one of a spectral resolution, SNR, color mapping, or the like. In one embodiment, the conditioning of the received signal includes, performing an STFT on the received signal to obtain a set of micro-doppler signatures associated with the received signal. Further, the method includes performing, intensity transformation on the set of micro-doppler signatures to obtain a transformed set of micro-doppler signatures. As a result, at least one of a spectral resolution or an SNR, of the transformed set of micro-doppler signatures is improved in comparison to a spectral resolution and an SNR, of the set of micro-doppler signatures.

In a further embodiment, the conditioning of the received signal includes, performing an STFT on the received signal to obtain an intensity plot. The method further includes performing intensity transformation on the intensity plot to obtain a transformed intensity plot. As a result, at least one of a color mapping or an SNR, of the transformed intensity plot is improved in comparison to a color mapping and an SNR, of the intensity plot.

At 408, the method includes providing the conditioned signal as an input to a trained AI model. The trained AI model may classify the object into one of the plurality of classes. At 410, the method includes determining whether the object is a UAV based on the output of the trained AI model. In additional embodiments, the method may further include training an Al model to obtain the trained AI model. Additionally, the trained AI model may be retrained based on the output of the trained AI model. Referring to FIG. 4B, at 410, the method includes taking over control of the object using jamming and spoofing techniques.

In some embodiments, taking over control of the object includes activating a jammer for a first time-period based on the determination that the object is the UAV. One or more jamming signals are transmitted by the jammer based on the range and the velocity of the object during the first time-period. Further, the method includes deactivating the jammer after the completion of the first time-period and activating a spoofer after the completion of the first time-period of the jammer. One or more spoofing signals are transmitted by the spoofer. The method further includes calibrating power of the one or more spoofing signals based on the range of the object. Communication is established between the object and the spoofer by the calibrated one or more spoofing signals. Further, one or more control functions of the UAV are remotely maneuvered based on the communication established between the object and the spoofer.

In further embodiments, upon the determination that the object is the UAV, the method may include determining free space path loss based on the range of the object. Further, the method may include activating a spoofer that transmits one or more spoofing signals. The method further includes calibrating power of the one or more spoofing signals based on the free space path loss to establish communication between the object and the spoofer by one or more spoofing signals. Further, one or more control functions of the UAV are remotely maneuvered based on the communication established between the object and the spoofer.

In furthermore embodiments, upon determination that the object is the UAV, the method may include determining a phase delay based on the range of the object and activating a spoofer. One or more spoofing signals are transmitted by the spoofer. The method further includes calibrating the phase of each of the one or more spoofing signals based on the phase delay. As a result, communication is established between the object and the spoofer by the calibrated one or more spoofing signals. Further, one or more control functions of the UAV are remotely maneuvered based on the communication established between the object and the spoofer.

In numerous embodiments, the method 400 may be performed by the processing unit 108. In numerous additional embodiments, the method 400 may be performed by one or more portions of the controller unit 206.

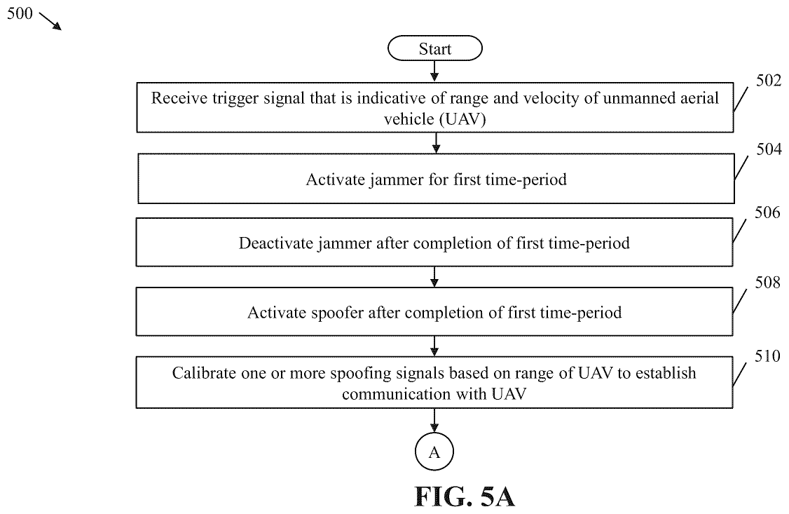

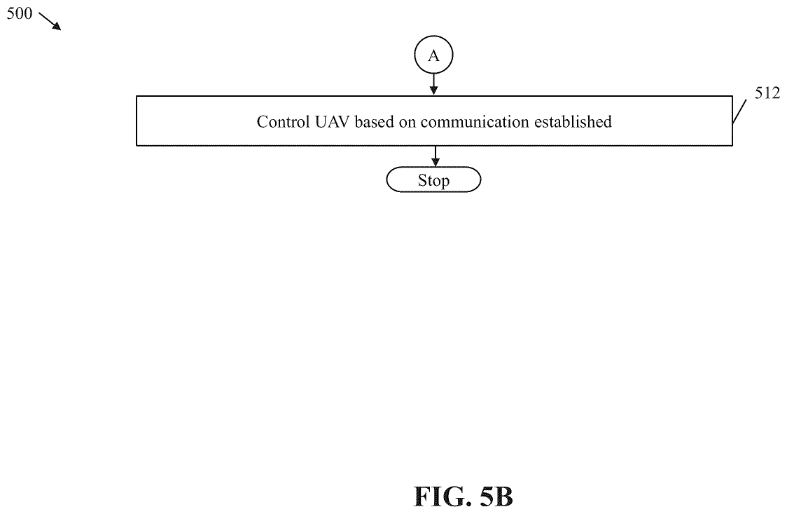

FIGS. 5A and 5B represent a flowchart 500 that illustrates a method for controlling an object, in accordance with an embodiment of the present disclosure. Referring to FIG. 5A, at 502, the method includes receiving a trigger signal that is indicative of a range and a velocity of a UAV.

At 504, the method includes activating a jammer for a first time-period in response to receiving the trigger signal. One or more jamming signals are transmitted by the jammer based on the range and the velocity of the UAV during the first time-period.

At 506, the method includes deactivating the jammer after the completion of the first time-period. At 508, the method includes activating a spoofer after the completion of the first time-period of the jammer. One or more spoofing signals are transmitted by the spoofer. At 510, the method further includes calibrating power of the one or more spoofing signals based on the range of the UAV. Communication is established between the UAV and the spoofer by the calibrated one or more spoofing signals.

Referring to FIG. 5B, at 512, the method includes remotely maneuvering one or more control functions of the object based on the communication established between the UAV and the spoofer.

In numerous embodiments, the method 500 may be performed by the processing unit 108. In numerous additional embodiments, the method 500 may be performed by one or more portions of the controller unit 206.

The present disclosure discloses various aspects of enhanced object detection and countermeasures. The utilization of intensity transformation to transform the set of micro-Doppler signatures result in improved spectral resolution and SNR of the set of micro-Doppler signatures. As a result, classification of the object based on the transformed micro-Doppler signatures results in efficient categorization of the object. Additionally, ‘false positives’ and ‘false negatives’ during detection of UAVs are prevented. The artificial neural network is further utilized to learn from micro-Doppler data and adapts to evolving drone behaviors, enhancing the detection accuracy, and reducing the occurrence of erroneous identifications. Additionally, the present disclosure includes a proprietarily designed AI model with practical datasets from different drone types, birds, and UAVs (fixed wings, quadcopters) that can classify different objects. Also, the communication between various components in the system for object detection and countermeasures is deterministic. As a result, the system operates with low latency.

Techniques consistent with the present disclosure provide, among other features, systems and methods for object detection and counter measures. In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the scope of the present disclosure, as described in the claims. Further, unless stated otherwise, terms such as “first” and “second” are used to arbitrarily distinguish between the elements such terms describe. Thus, these terms are not necessarily intended to indicate temporal or other prioritization of such elements.

What is claimed is:

1. A method for object detection and counter measures, the method comprising:
receiving a signal reflected by an object in an environment;
conditioning the received signal to vary one or more parameters associated with the received signal;
providing the conditioned signal as an input to a trained artificial intelligence (AI) model; and
determining whether the object is an unmanned aerial vehicle (UAV) based on an output of the trained AI model.

2. The method of claim 1, wherein the conditioning of the received signal comprises performing:
a Short Time Fourier Transform (STFT) on the received signal to obtain a set of micro-doppler signatures; and
intensity transformation on the set of micro-doppler signatures to obtain a transformed set of micro-doppler signatures, wherein
at least one of a spectral resolution or a signal to noise ratio (SNR), of the transformed set of micro-doppler signatures is improved in comparison to a spectral resolution and an SNR, of the set of micro-doppler signatures,
at the one or more parameters include the spectral resolution and the SNR, and
at the conditioned signal corresponds to the transformed set of micro-doppler signatures.

3. The method of claim 1, wherein the conditioning of the received signal comprises performing:
a Short Time Fourier Transform (STFT) on the received signal to obtain an intensity plot; and
intensity transformation on the intensity plot to obtain a transformed intensity plot, wherein
at at least one of a color mapping or a signal to noise ratio (SNR), of the transformed intensity plot is improved in comparison to a color mapping and an SNR, of the intensity plot,
at the one or more parameters include the color mapping and the SNR, and the conditioned signal corresponds to the transformed intensity plot.

4. The method of claim 1, further comprising training, an AI model based on a dataset to obtain the trained AI model, wherein the dataset includes a plurality of micro-doppler signatures associated with a plurality of classes.

5. The method of claim 1, further comprising retraining the trained AI model based on the output of the trained AI model.

6. The method of claim 1, wherein the environment corresponds to an airspace.

7. The method of claim 1, further comprising:
detecting a range and a velocity of the object, based on the received signal, wherein the signal is conditioned in response to detecting the range and the velocity of the object; and
taking over control of the object based on the range and the velocity, in response to the determination that the object is the UAV.

8. The method of claim 7, wherein taking over the control of the object comprises:
activating a jammer for a first time period based on the determination that the object is the UAV, wherein one or more jamming signals are transmitted by the jammer based on the range and the velocity of the object during the first time period;
deactivating the jammer after the completion of the first time period;
activating a spoofer after the completion of the first time period, wherein one or more spoofing signals are transmitted by the spoofer;
calibrating power of the one or more spoofing signals based on the range of the object, wherein communication is established between the object and the spoofer by the calibrated one or more spoofing signals; and
remotely maneuvering one or more control functions of the object based on the communication established between the object and the spoofer.

9. The method of claim 1, further comprising:
detecting a range of the object based on the received signal, wherein the signal is conditioned in response to detecting the range of the object;
determining free space path loss based on the range of the object;
activating a spoofer, wherein one or more spoofing signals are transmitted by the spoofer;
calibrating power of the one or more spoofing signals based on the free space path loss, wherein communication is established between the object and the spoofer by the calibrated one or more spoofing signals; and
remotely maneuvering one or more control functions of the object based on the communication established between the object and the spoofer.

10. The method of claim 1, further comprising:
detecting a range of the object based on the received signal, wherein the signal is conditioned in response to detecting the range of the object;
determining a phase delay based on the range of the object;
activating a spoofer, wherein one or more spoofing signals are transmitted by the spoofer;
calibrating a phase of each of the one or more spoofing signals based on the phase delay, wherein communication is established between the object and the spoofer by the calibrated one or more spoofing signals; and
remotely maneuvering one or more control functions of the object based on the communication established between the object and the spoofer.

11. A method for controlling an object, the method comprising:
receiving a trigger signal that is indicative of a range and a velocity of an unmanned aerial vehicle (UAV);
activating a jammer for a first time period in response to receiving the trigger signal, wherein one or more jamming signals are transmitted by the jammer based on the range and the velocity of the UAV during the first time period;
deactivating the jammer at the completion of the first time period;
activating a spoofer at the completion of the first time period, wherein one or more spoofing signals are transmitted by the spoofer;
calibrating power of the one or more spoofing signals based on the range of the UAV, wherein communication is established between the UAV and the spoofer by the calibrated one or more spoofing signals; and
remotely maneuvering one or more control functions of the UAV based on the communication established between the UAV and the spoofer.

12. A system for object detection and counter measures, comprising:
a processing unit configured to:
receive a signal reflected by an object in an environment; and
condition the received signal to vary one or more parameters associated with the received signal; and
a trained artificial intelligence (AI) model configured to:
receive the conditioned signal; and
classify the object into one of a plurality of classes based on the conditioned signal, wherein the processing unit is further configured to determine whether the object is an unmanned aerial vehicle (UAV) based on the classification of the object into one of the plurality of classes.

13. The system of claim 12, comprising:
a jammer coupled to the processing unit; and
a spoofer coupled to the jammer and the processing unit, wherein the processing unit is further configured to:
at detect a range and a velocity of the object based on the received signal, wherein the signal is conditioned in response to detecting the range and the velocity of the object; and
at orchestrate the jammer and the spoofer based on the range and the velocity, in response to the determination that the object is the UAV, to achieve a control of the object.
